(19) United States
(12) Patent Application Publication
(10) Pub. No.: US 2012/0048971 A1
(43) Pub. Date: Mar. 1, 2012

(54) MULTIPURPOSE GAS TURBINE COMBUSTOR SECONDARY FUEL NOZZLE FLANGE

(75) Inventors: Karthick KALEESWARAN, Banglalore (IN); Nitin SARJA, Banglalore (IN); A. M. SATISH, Banglalore (IN)

(73) Assignee: GENERAL ELECTRIC COMPANY, Schenectady, NY (US)

(21) Appl. No.: 12/871,171

(22) Filed: Aug. 30, 2010

(51) Int. Cl. B05B 1/00

(52) U.S. Cl. 239/602

(57) ABSTRACT

One exemplary embodiment of a fuel nozzle flange includes an elongated flange body including a radial mounting flange at an aft end thereof and a face surface at a forward end thereof. The flange body has a first, axially-oriented through-bore adapted to receive a first fuel supply pipe at the forward end; a second, radially-oriented bore intersecting the first axially-oriented bore and adapted to receive a second fuel supply pipe; and a third axially-oriented through-bore adapted to receive one end of a flame detector device at the forward end.

### BACKGROUND OF THE INVENTION

This invention relates to gas turbine combustor technology and, more specifically, to a fuel nozzle flange construction for supporting the nozzle, a flame detector and the pipes or manifolds that supply fuel and air to the nozzle.

Prior secondary fuel nozzle flange designs resulted in various field issues and component rejections due to problems related to fuel flow. Many of these problems were due to the complex design of the secondary fuel nozzle flange, which in turn dictated both straight and bent concentric fuel-supply tubing and welding, inclined hole drilling, and loose tolerances related to manufacturing, all of which can prove to be problematic.

There remains a desire for a less complex secondary fuel nozzle flange construction that not only eliminates or minimizes the problems experienced to date in connection with conventional flange construction, but that also provides further benefits in terms of flexibility with respect to the ability to switch between transfer and transferless combustion configurations, and the type of mounting utilized to support the flame detector.

### BRIEF SUMMARY OF THE INVENTION

In accordance with an exemplary but non-limiting embodiment a flange is provided that comprises an elongated flange body including a radial mounting flange at an aft end thereof and a face surface at a forward end thereof; said flange body having a first, axially-oriented through-bore adapted to receive a first fuel supply pipe at said forward end, a second, radially-oriented bore intersecting said first axially-oriented bore and adapted to receive a second fuel supply pipe, and a third axially-oriented through-bore adapted to receive one end of a flame detector device at said forward end.

In accordance with another exemplary but non-limiting embodiment a fuel nozzle flange comprising an elongated flange body including a radial mounting flange at an aft end thereof and a face surface at a forward end thereof; the flange body having a first, axially-oriented through-bore adapted to receive a first fuel supply pipe at the forward end, a second, radially-oriented bore intersecting the first axially-oriented bore and adapted to receive a second fuel supply pipe, and a third axially-oriented through-bore adapted to receive one end of a flame detector device at the forward end wherein the flange body is substantially cylindrical in shape but with a flat extending axially along a chordal segment of the flange body, an inlet to the second radially-oriented bore located on the flat wherein said first, axially-oriented through-bore has an inlet at the forward end of the flange body and an outlet at the aft end of the flange body within the mounting flange, and further wherein a counter-bore extends from the outlet to a location adjacent the inlet and axially forwardly of the second, radially-oriented bore.

In accordance with still another exemplary but non-limiting embodiment the present invention provides a nozzle flange comprising an elongated flange body including a radial mounting flange at an aft end thereof and a face surface at a forward end thereof; the flange body having a first, axially-oriented bore open at an aft end of the flange body and closed adjacent the forward end; a second, radially-oriented bore intersecting the first axially-oriented bore and adapted to receive a first fuel supply pipe; and a third radially extending bore intersecting the first axially-oriented bore.

The invention will now be described in greater detail in connection with the drawings identified below.

### BRIEF DESCRIPTION OF THE DRAWINGS

FIG. 1 illustrates a conventional secondary fuel nozzle and associated fuel nozzle flange construction;

FIG. 2 is a perspective view of a secondary nozzle fuel flange in accordance with a first exemplary but nonlimiting embodiment of the invention;

FIG. 3 is another perspective view of the secondary fuel nozzle flange shown in FIG. 2;

FIG. 4 is a perspective view of the secondary fuel nozzle flange shown in FIGS. 2 and 3, but also illustrating connection to a secondary fuel nozzle and related fuel supply piping/manifold;

FIG. 5 is a perspective view, partially cut away, of the secondary fuel nozzle flange and nozzle construction shown in FIG. 4;

FIG. 6 is a perspective view similar to FIG. 4, but illustrating a conventional flange-type mount for the flame detector;

FIG. 7 is a perspective view of a secondary fuel nozzle flange in accordance with a second exemplary but nonlimiting embodiment of the invention;

FIG. 8 is another perspective view of the secondary fuel nozzle flange shown in FIG. 7;

FIG. 9 is a perspective view of the secondary fuel nozzle flange shown in FIGS. 7 and 8, but also illustrating connection to a secondary fuel nozzle and related fuel supply piping/manifold, along with a flame detector directly threaded to the flange;

FIG. 10 is a perspective view similar to FIG. 9, but illustrating a conventional flange-type mount for a flame detector; and

FIG. 11 is a perspective view, partially cut away, of the secondary fuel nozzle flange and nozzle construction shown in FIG. 10, but with the flame detector omitted.

### DETAILED DESCRIPTION OF THE INVENTION

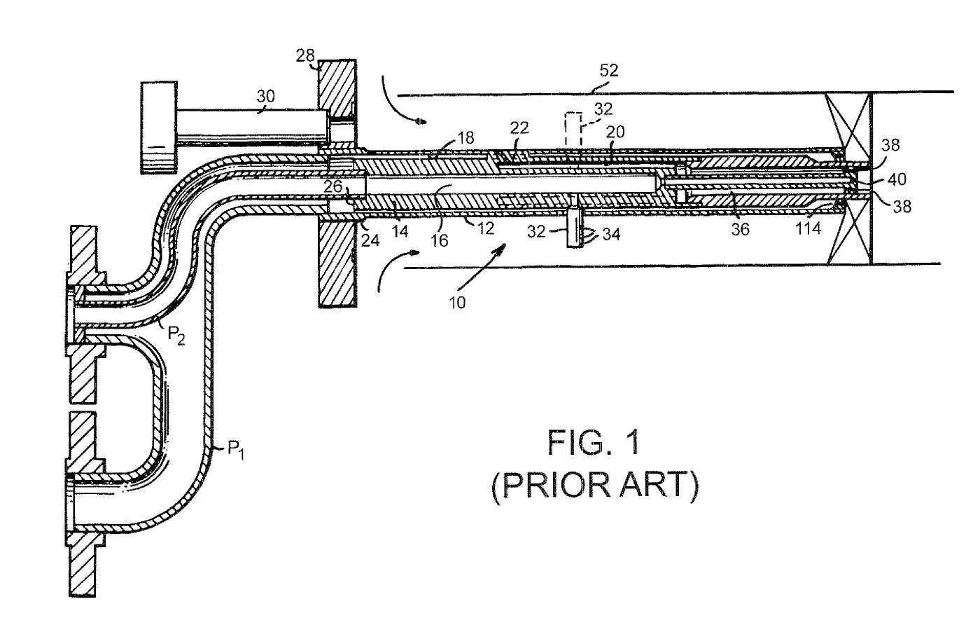

With reference initially to FIG. 1, a two-stage (pre-mixed/diffusion), gas-only, secondary fuel nozzle assembly 10 in accordance with a known construction is typically located within a combustor center body (not shown) that also houses an annular array of primary nozzles surrounding the centrally-located secondary nozzle.

For combustors incorporating a secondary fuel nozzle (as at 10) in a two-stage (or transfer) combustion process, fuel is supplied to sustain a flame by a diffusion pipe P1, and to sustain a premixed flame by a pipe P2 which, at the inlet to the secondary fuel nozzle assembly 10, are arranged concentrically relative to each other.

The secondary fuel nozzle assembly 10 includes an outer sleeve 12 and an inner, concentrically arranged hollow core 14 provided with a central bore forming a premix fuel passage 16. The radial gap between the core 14 and the sleeve 12 provides a diffusion fuel passage 18 therebetween. A plurality of axial air passages 20 are formed in surrounding relationship to the premix passage 16. A like number of radial wall portions (for example, 4) are arranged about the end of the sleeve portion 12 and each includes an inclined radial aperture 22 for permitting air within the liner to enter a corresponding air passage 20.

The forward end of nozzle 10 includes an enlarged outer end 24 and an inner end 26 which are adapted to receive the fuel pipes P1, P2, respectively, within a fuel nozzle mounting flange (or simply, “fuel nozzle flange”) 28 which also mounts a flame detector 30.

A plurality of radial holes are provided about the circumference of the forward portion of the fuel nozzle assembly 10, permitting a like number of radial gas injector tubes 32 to be received therein to thereby establish communication with the premix fuel passage 16. Each tube 32 is provided with a plurality of orifices 34 so that fuel from the premix fuel passage 16 may be discharged into the area between the nozzle assembly and the liner for mixing with combustion air within the liner. The gas injectors 30 are designed to evenly distribute fuel into the air flow, particularly because good mixing of fuel and air inside the liner is necessary to minimize NOx emissions.

Briefly, combustion air will enter the secondary nozzle assembly 10 via holes 22 and will flow through passages 20 and space 36 for discharge through swirler slots 38. It will be further apparent that fuel from premix pipe P2 will flow through the premix passage 16 pilot bore 40 and pilot orifice 42. This fuel, along with air from swirler slots 38 provide a diffusion flame sub pilot. At the same time, a majority of the fuel supplied to the premix fuel passage 16 will flow into the gas injectors 30 for discharge from the respective orifices 34 into the liner where it is mixed with air. The above-described nozzle construction provides for improved transfer to the premix mode of operation via a diffusion flame and, once in the premix mode, operates to turn off the diffusion flame and start the premix flame, thus enabling the gas turbine to operate at its design point over extended periods of time. A more detailed description of the secondary fuel nozzle per se may be found in commonly-owned U.S. Pat. No. 5,199,265.

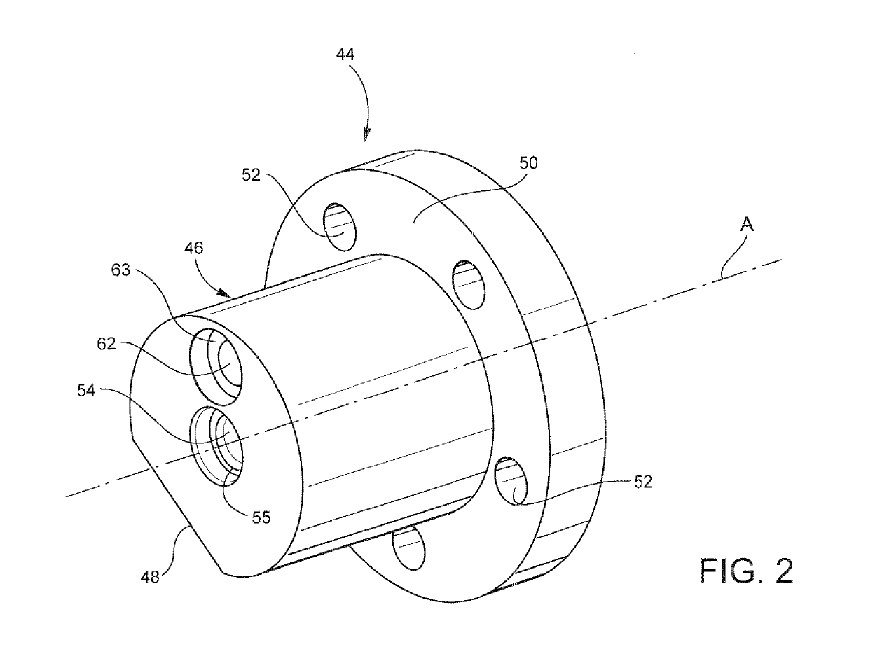

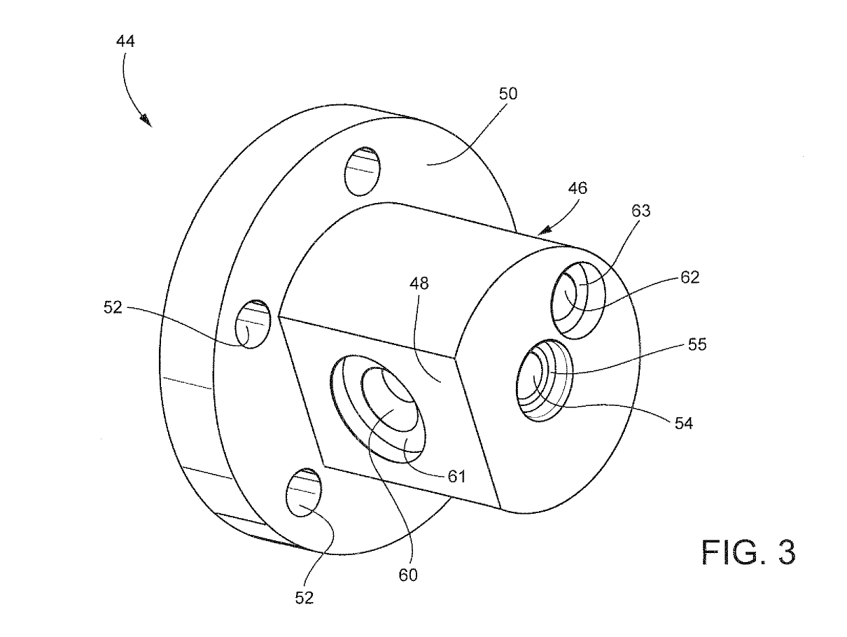

With this background, reference is now made to FIGS. 2 and 3 which illustrate a first exemplary but non-limiting embodiment of a secondary fuel nozzle flange 44 that represents an improved design as compared to the flange 28 in FIG. 1. The fuel nozzle flange 44 includes a generally-round or cylindrical elongated flange body 46 formed to have an axially-extending flat surface (or simply “flat”) 48. The flat 48 may be defined as extending along a chordal segment of the body 46, truncating about 90° degrees of the flange body circumference. At one end of the flange body 46, there is a radial mounting plate or flange 50 provided with an array of bolt (or other suitable fastener) holes 52 for attaching the fuel nozzle flange 44 to the rear wall of the turbine combustor.

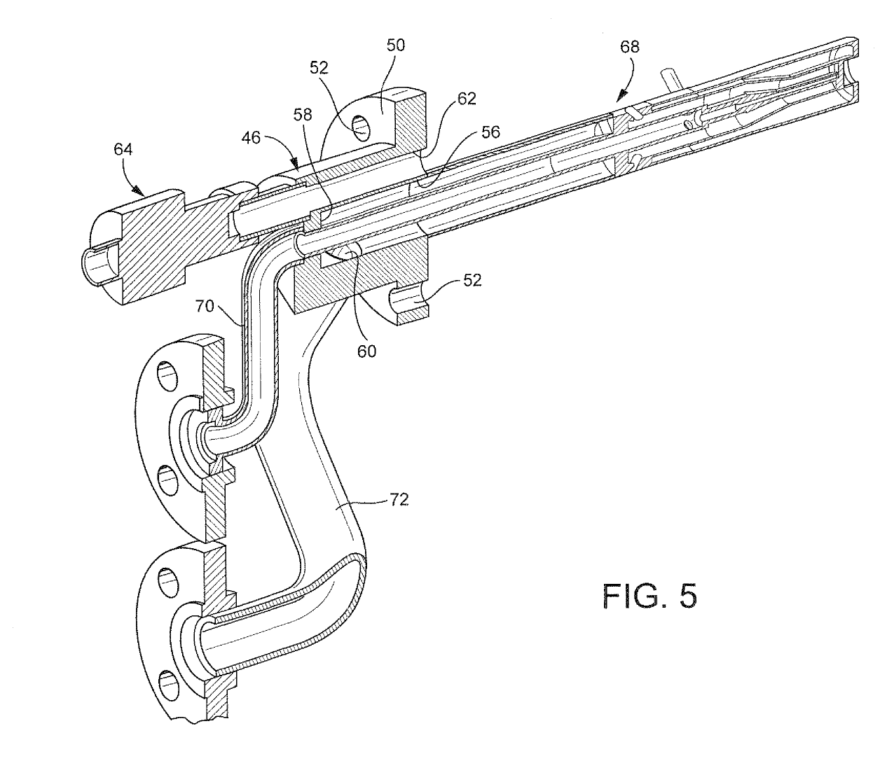

A center bore (or first axial through-bore) 54 extends through the flange body 46, aligned with longitudinal axis A (FIG. 2) of the flange 44. As best seen in FIG. 5, the flange body 46 is also formed with a concentric, blind counter bore 56, closed at the aft end of the flange body at a radial shoulder 58.

A radially-oriented bore 60 extends from the flat 48 radially-inwardly of the flange body 46 and intersects with the blind counter bore 56 (as best seen in FIGS. 3 and 5).

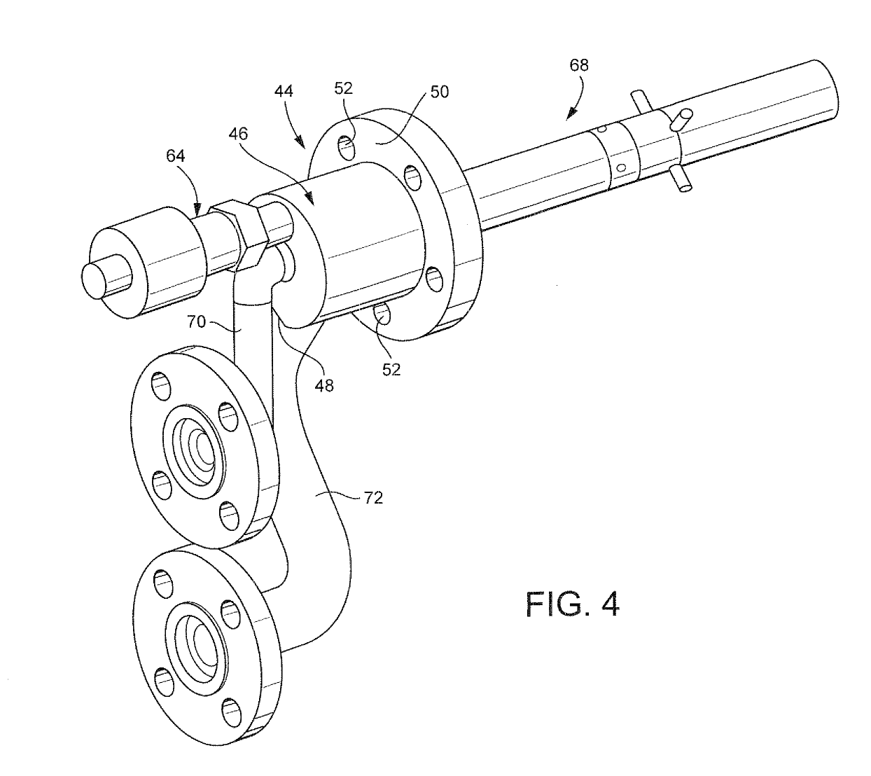

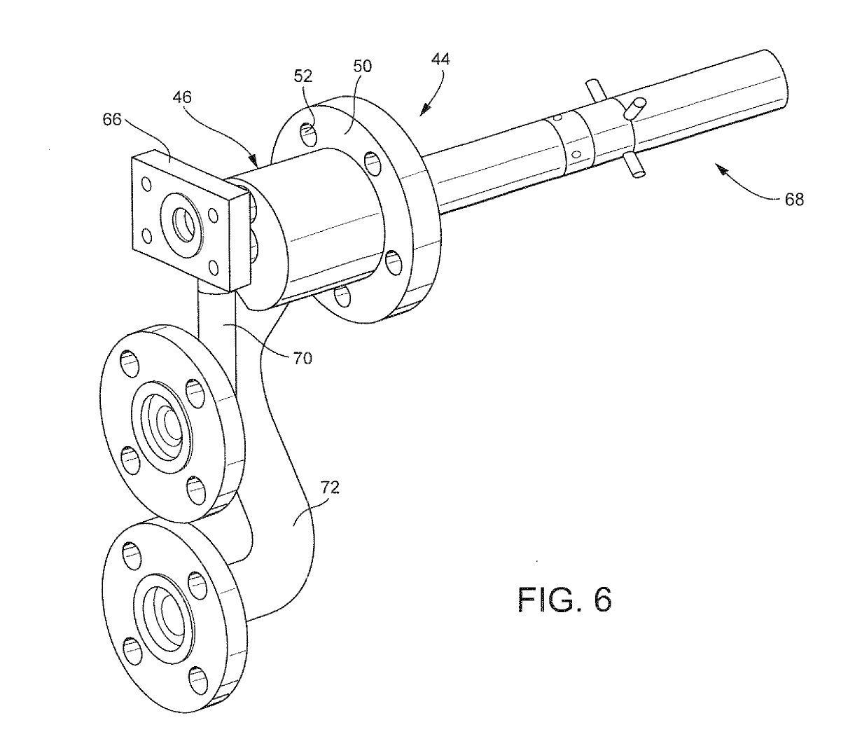

A third axial through bore 62 extends parallel to the center bore 54 but offset from the longitudinal axis of the flange body 46. The third axial through bore 62 is adapted to mount a flame detector 64 (FIGS. 4-6) by means of a direct threaded connection shown in FIG. 5 or, optionally, by a conventional flange-type mount shown in FIG. 6 where a flange block 55 is attached to the flange body 46 in alignment with the bore 62 and adapted to mount the flame detector.

FIGS. 4-5 also show a secondary fuel nozzle 66 fitted to the flange 44 so that the outer fuel passage of the secondary fuel nozzle aligns with the blind counter bore 56 and the center passage of the secondary fuel nozzle aligns with the center bore 54. Fuel manifolds 70, 72 are connected to the center bore 54 and radial port, 60 respectively for supplying fuel to the radially inner and outer fuel passages as described above. Note that the forward ends of first and second axial through-bores 54, 62 as well as the inlet to the radial bore 60 may be counterbored at 55, 63 and 61, respectively, to facilitate attachment (for example, by screw threads) of the fuel manifolds and flame detector.

It will be appreciated that both manifolds 70, 72 will be utilized in a diffusion/premix (or transfer-type) secondary fuel nozzle. For a transfer-less combustion process, the manifold 70 can simply be removed and the center bore 54 plugged.

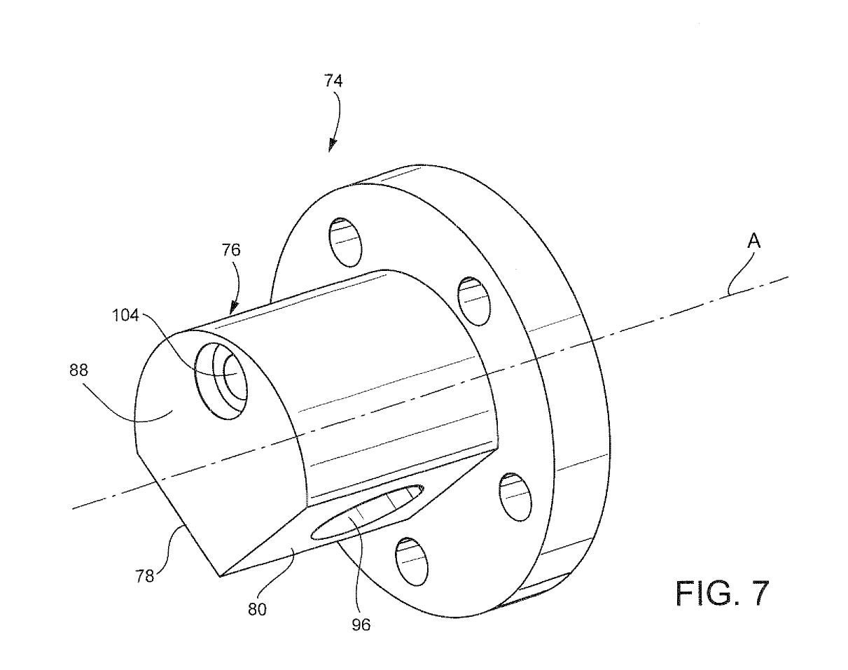

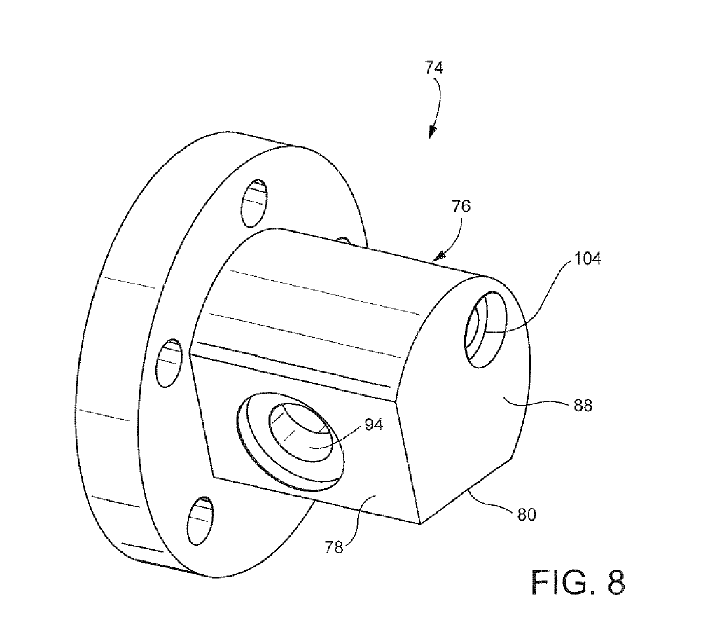

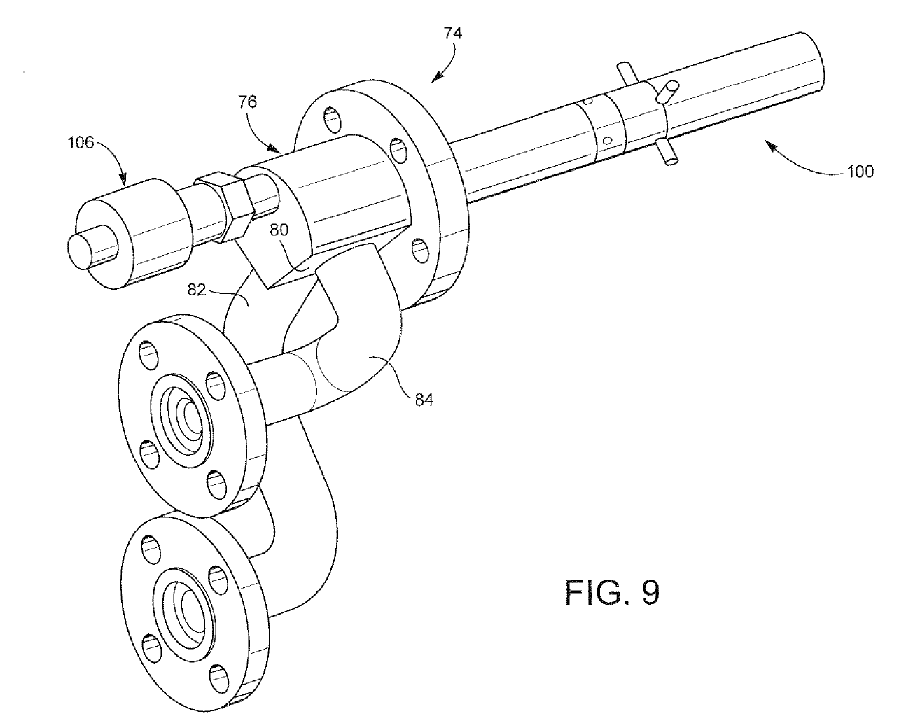

FIGS. 7-11 illustrate an alternative exemplary embodiment of a secondary fuel nozzle flange 74. In this embodiment, the elongated flange body 76 is formed generally of the same shape as the flange 44 but with first and second flats 78, 80 preferably at a 90 degree angle relative to each other. This permits the fuel supply tubes or manifolds 82, 84 (FIGS. 9-11) to be connected to the oppositely-directed flats.

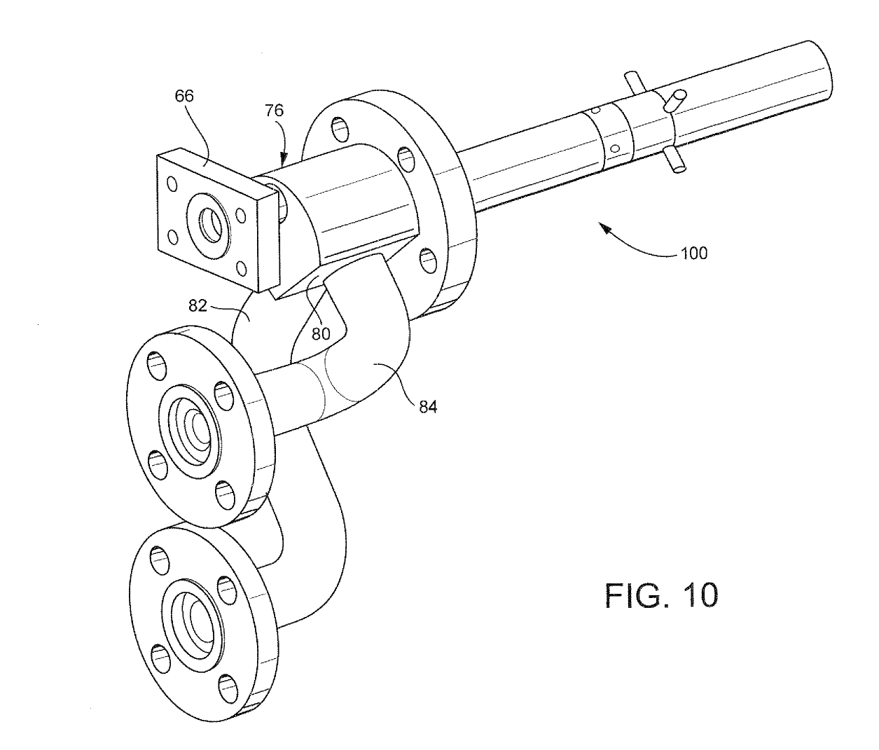

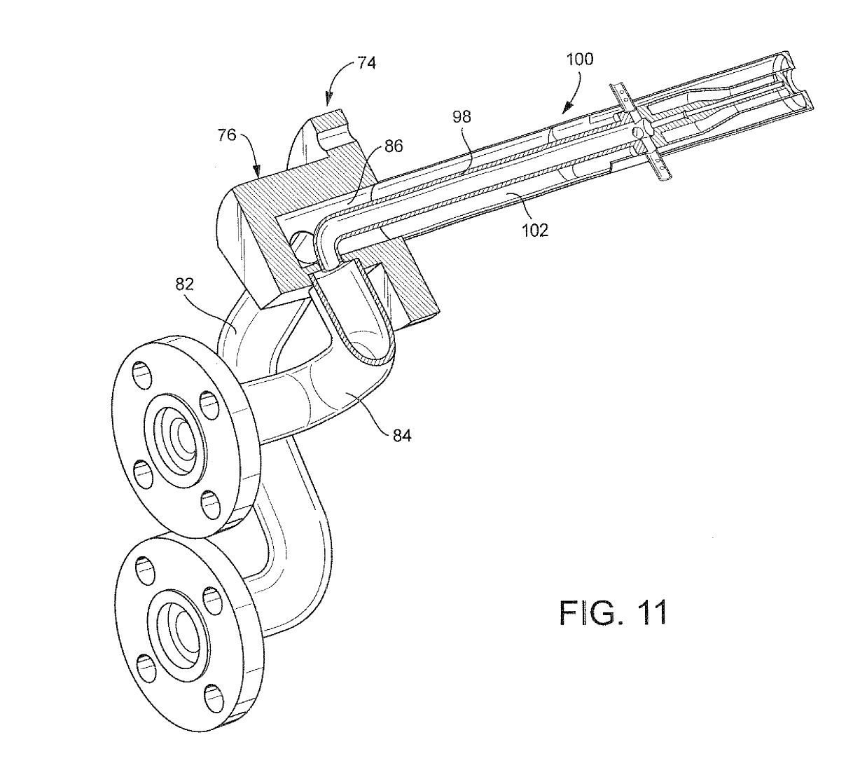

More specifically, and as best seen in FIG. 11, a single, blind center bore 86 is located along the longitudinal center axis A of the fuel nozzle flange body 74, closed at the forward end of the fuel nozzle flange by the forward end face 88. Radially-oriented bores 90, 92 extend from inlets 94, 96 at the flats 78, 80 to the center bore 86. The supply pipe or manifold 84 is fixed to the fuel nozzle flange bore 96 so as to communicate only with a center tube 98 (corresponding to core 44 in FIG. 1) of the secondary fuel nozzle 100. Bore 94 opens to the center bore 86 and communicates with the radially outer passage 102 in the secondary fuel nozzle 100. An offset bore 104 (FIGS. 7, 8 and 10) remains for mounting the flame detector 106, again with either a direct threaded connection or a conventional flange-type mount (FIG. 10), utilizing the flange block 66. Otherwise, the manner in which the alternative secondary fuel nozzle flange is mounted and used is essentially the same as described herein above with respect to the first configuration illustrated in FIGS. 2-6. For transferless combustion, the manifold 84 can be removed and the bore 96 plugged, or the manifold 84 can be plugged at its opposite end. As in the first exemplary embodiment, the 94, 96 may be counterbored at their respective inlets to facilitate attachment of the manifolds 82, 84, and bore 104 may be counterbored to facilitate attachment of the flame detector 76.

For both exemplary embodiments smooth fuel flow is ensured by the relatively simple flange body design and both may be utilized for transfer as well as transfer-less type configurations. Both embodiments also support alternative flame detector mounting configurations. Further simplification is achieved by providing the fuel inlets with identical diameters and threads.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A fuel nozzle flange comprising:
an elongated flange body including a radial mounting flange at an aft end thereof and a face surface at a forward end thereof; said flange body having a first, axially-oriented through-bore adapted to receive a first fuel supply pipe at said forward end, a second, radially-oriented bore intersecting said first axially-oriented bore and adapted to receive a second fuel supply pipe, and a third axially-oriented through-bore adapted to receive one end of a flame detector device at said forward end.

2. The nozzle flange of claim 1 wherein said flange body is substantially cylindrical in shape but with a flat extending axially along a chordal segment of said flange body, an inlet to said second radially-oriented bore located on said flat.

3. The nozzle flange of claim 1 wherein said first, axially-oriented through-bore has an inlet on said face surface of said forward end of said flange body and an outlet at said aft end of said flange body within said mounting flange, and further wherein a counter-bore extends from said outlet to a location adjacent said inlet and axially forwardly of said second, radially-oriented bore.

4. The nozzle flange of claim 2 wherein said first, axially-oriented through-bore has an inlet on said face surface of said forward end of said flange body and an outlet at said aft end of said flange body within said mounting flange, and further wherein a counter-bore extends from said outlet to a radial shoulder located adjacent said inlet and axially forwardly of said second, radially-oriented bore.

5. The nozzle flange of claim 1 wherein said third axially-oriented through-bore is threaded at said forward end.

6. The nozzle flange of claim 1 wherein said first, axially-oriented through-bore extends along a longitudinal center axis of said flange body.

7. The nozzle flange of claim 6 wherein said third axially-oriented through-bore extends substantially parallel to said first, axially-oriented through-bore.

8. The nozzle flange of claim 3 in combination with a secondary fuel nozzle wherein an outer tube of said secondary fuel nozzle is engaged within said counterbore, and closed at a forward end by said radial shoulder, and an inner tube of said secondary fuel nozzle passes through said outer tube and through said first, axially-oriented through-bore such that a first fuel passage is established and enabled for connection with said first fuel supply pipe, and a second fuel passage is established and enabled for connection with said second fuel supply pipe, with said first and second fuel passages isolated from each other.

9. The nozzle flange of claim 4 in combination with a secondary fuel nozzle wherein an outer tube of said secondary fuel nozzle is engaged within said counterbore, and closed at a forward end by said radial shoulder, and an inner tube of said secondary fuel nozzle passes through said outer tube and through said first, axially-oriented through-bore such that a first fuel passage is established and enabled for connection with said first fuel supply pipe, and a second fuel passage is established and enabled for connection with said second fuel supply pipe, with said first and second fuel passages isolated from each other.

10. The nozzle flange of claim 1 wherein said radial mounting flange is provided with a plurality of circumferentially-spaced fastener holes.

11. A fuel nozzle flange comprising:
an elongated flange body including a radial mounting flange at an aft end thereof and a face surface at a forward end thereof; said flange body having a first, axially-oriented through-bore adapted to receive a first fuel supply pipe at said forward end, a second, radially-oriented bore intersecting said first axially-oriented bore and adapted to receive a second fuel supply pipe, and a third axially-oriented through-bore adapted to receive one end of a flame detector device at said forward end wherein said flange body is substantially cylindrical in shape but with a flat extending axially along a chordal segment of said flange body, an inlet to said second radially-oriented bore located on said flat wherein said first, axially-oriented through-bore has an inlet at said forward end of said flange body and an outlet at said aft end of said flange body within said mounting flange, and further wherein a counter-bore extends from said outlet to a location adjacent said inlet and axially forwardly of said second, radially-oriented bore.

12. The nozzle flange of claim 11 wherein said first, axially-oriented through-bore has an inlet at said forward end of said flange body and an outlet at said aft end of said flange body within said mounting flange, and further wherein said location includes a radial shoulder.

13. The nozzle flange of claim 11 wherein said first, axially-oriented through-bore extends along a longitudinal center axis of said flange body wherein said third axially-oriented through-bore extends substantially parallel to said first, axially-oriented through-bore.

14. The nozzle flange of claim 12 in combination with a secondary fuel nozzle wherein an outer tube of said secondary fuel nozzle is engaged within said counterbore, and closed at a forward end by said radial shoulder, and an inner tube of said secondary fuel nozzle passes through said outer tube and through said first, axially-oriented through-bore such that a first fuel passage is established and enabled for connection with said first fuel supply pipe, and a second fuel passage is established and enabled for connection with said second fuel supply pipe, with said first and second fuel passages isolated from each other.

15. A nozzle flange comprising:
an elongated flange body including a radial mounting flange at an aft end thereof and a face surface at a forward end thereof; said flange body having a first, axially-oriented bore open at an aft end of the flange body and closed adjacent said forward end; a second, radially-oriented bore intersecting said first axially-oriented bore and adapted to receive a first fuel supply pipe; and a third radially extending bore intersecting said first axially-oriented bore.

16. The nozzle flange of claim 15 wherein said flange body further comprises a fourth, axially-oriented through-bore adapted to receive one end of a flame detector device at said forward end of said flange body.

17. The nozzle flange of claim 15 wherein said flange body is substantially cylindrical in shape, with a pair of flats extending axially along adjacent chordal segments of said flange body, inlets to said second and third radially-oriented bores located in respective ones of said pair of flats.

18. The nozzle flange of claim 16 wherein said fourth bore is substantially parallel to said first bore.

19. The nozzle flange of claim 17 wherein said pair of flats are substantially perpendicular to each other.

20. The nozzle flange of claim 15 wherein said radial mounting flange is formed with a plurality of bolt holes about a peripheral edge thereof.
